(19) United States
(12) Patent Application Publication
(10) Pub. No.: US 2003/0060735 A1
(43) Pub. Date: Mar. 27, 2003

(54) Therapeutic ultrasonic delivery system

(76) Inventors: Kenneth W. Coffey, Tulsa, OK (US); Gregory F. Dorholt, Tulsa, OK (US)

Correspondence Address: Frank L. Hart, Attorney at Law, 8911 S. 73rd East Ave., Tulsa, OK, 74133, US

(21) Appl. No.: 09/961,815

(22) Filed: Sep. 25, 2001

(51) Int. Cl. A61H 1/00

(52) U.S. Cl. 601/2

(57) ABSTRACT

A therapeutic ultrasonic delivery system has coupling apparatus associated therewith which has properties of being adhereable to on operating surface of the ultrasonic delivery system, removable in unitary form from the operating surface of an ultrasonic delivery system, and which, upon being subjected to water, becomes nonadherable.

### TECHNICAL FIELD

The subject invention relates to a therapeutic ultrasonic delivery system. More particularly, this invention relates to the coupling material, apparatus or media used for passing the sound waves from a transducer to an individual receiving treatment.

### BACKGROUND ART

It is well known in the medical arts that ultrasound can be used to treat and evaluate injuries. It has been found that the proper use of ultrasound enhances healing of the injury. This is most important in the treatment of elderly patients whose natural ability to heal is significantly diminished. It is further documented that, without the use of ultrasound treatment, particularly in bone injuries of the elderly, the injury often results in permanent disability or requires prosthetic replacement.

In the operation of an ultrasound system, ultrasonic pulses are transmitted from an operative surface of the ultrasonic delivery system onto the skin of an individual adjacent an injury locus. For purposes of this discussion, the operative surface of the ultrasonic delivery system will be the general surface area of the system which transmits the ultrasonic pulses, and which most commonly is the transducer. It should be understood however, that this operative face can be of various configurations.

Heretofore, there has also been a great deal of research directed toward the properties of the ultrasonic pulses. Properties such as the power density, RF signals, range of duration of each ultrasonic pulse, range of pulse frequencies, and length of treatments, to name a few. As one can well imagine, the variables encountered in determining a recommended treatment program are many and are often inordinately affected by undesirable application of the pulses to the patient.

It is well known in the art that ultrasonic pulses attenuate rapidly in gases, such as air and propagation of the ultrasonic pulses from the operative surface to the injury must be through a medium comprised of solids and liquids in order for the ultrasonic pulses to be efficiently transmitted. In order to increase the efficiency and benefits obtainable by the patient, ultrasonically conducting coupling gels were interspersed between the operating surface of the transducer and the skin of the patient receiving treatment. These gels were directly placed on the patients skin and the transducer was urged into the gel, thereby enhancing the coupling from undesirable and detrimental air migration between the surfaces.

It has been found however, that no matter how careful and skilled the operator, the distance between the operating face of the transducer and the skin of the patient varies greatly during the required movement of the transducer over the skin. Such changes of thickness markedly alter the beneficial effects received by the patient. Further, the conducting coupling gels are of a consistency which is generally repugnant to the patients and can be damaging to clothing or other items coming into contact therewith.

The present invention is therefore directed to overcoming one or more of the heretofore problems, as set forth above.

### DISCLOSURE OF THE INVENTION

In one aspect of the invention, a coupling apparatus is provided for a therapeutic ultrasonic delivery system. The coupling apparatus has first and second opposed, removable protective coverings. An adhereable, conductive hydro gel pad is positioned between the removable protective coverings. This hydro gel pad has properties of being adhereable to an operating face of an ultrasonic generating system, of being removable therefrom in unitary form, and portions of said hydro gel pad, upon being subjected to water, becoming nonadherable.

In another aspect of the invention, an ultrasonic delivery system is provided for therapeutic use. The system has an ultrasonic generating apparatus which has an operative surface positionable adjacent a skin location of an individual. An adhereable, conductive hydro gel pad is removeably connected to the operative surface and has the physical property of having surface portions being nonadhereable in response to being wetted with water.

In a further aspect of this invention, a method is provided for treating an individual with therapeutic ultra sound via the operating surface of an ultrasound generating system. In the method, water is applied to the skin of the individual to be treated. A conductive hydro gel pad is adhered over substantially the complete operative surface of the ultrasound generating system. The hydro gel pad has the physical properties of being removable in unitary form and portions of the hydro gel pad, upon being subjected to water are nonadhereable. The ultrasound generating system is then operated with the operating surface thereof and the water covered skin in intimate contact with the conductive hydro gel pad.

### BRIEF DESCRIPTION OF THE DRAWINGS

FIG. 1 is a diagrammatic side view of the coupling apparatus of this invention;

FIG. 2 is a diagrammatic plan view of the adhereable, conductive hydro gel pad showing the reinforcing elements thereof; and

FIG. 3 is a diagrammatic side view of a therapeutic ultrasonic delivery system being used to therapeutically treat a patient.

### BEST MODE FOR CARRYING OUT THE INVENTION

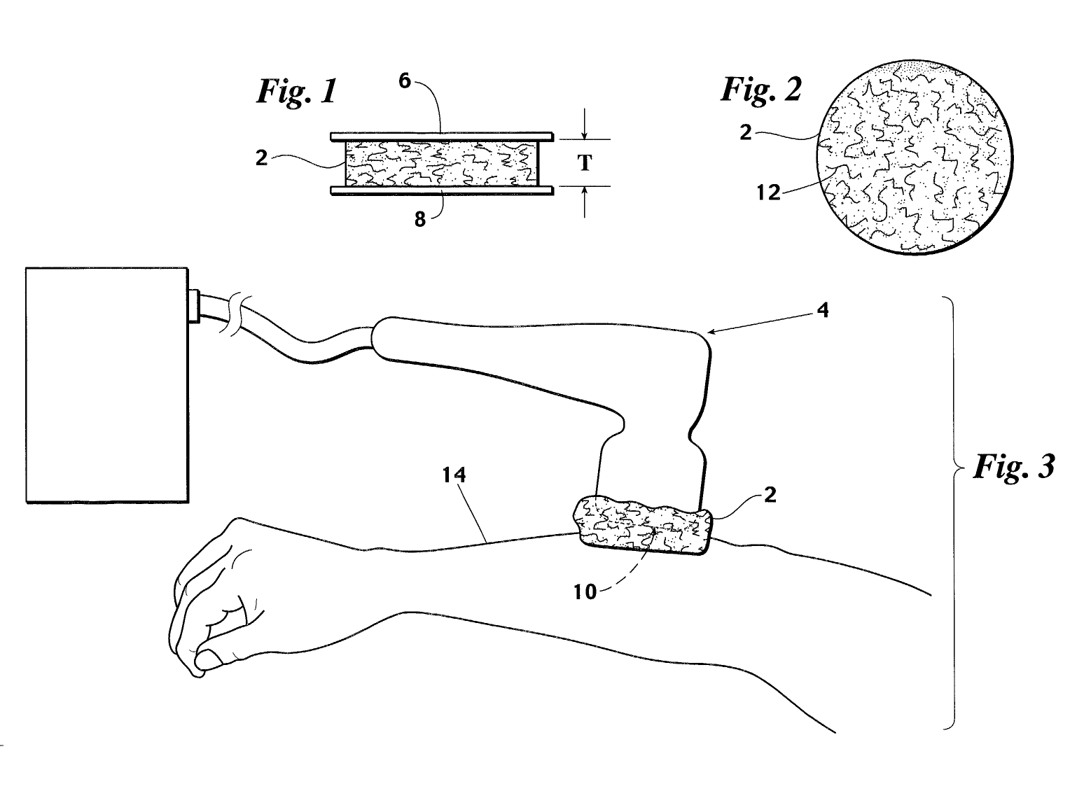

Referring to FIG. 1, a coupling material or adhereable, conductive hydro gel pad 2 for an ultrasonic delivery system 4 is shown positioned within its protective coverings 6, 8. These protective coverings 6,8 are removed for connecting the hydro gel pad 2 to an operating surface 10 of the ultrasonic delivery system 4 as shown in FIG. 4.

The protective coverings 6,8 can be formed of various materials so long as they are easily removable from the hydro gel pad 2 without damage to said pad 2 and they function to retard the escape of moisture from the pad 2. Examples of materials that can be used for forming the protective coverings are organic plastic films and waxed paper. Organic plastic films are preferred.

Referring to FIGS. 2 and 3 , the adhereable, conductive hydro gel pad 2 is of a type which is adhereable to the operating face 10 of the ultrasonic generating system 4 and which has properties of being nonadherable over areas of the gel which are contacted by or wetted by water, as will later be more fully explained when referring to the method of using the invention.

The hydro gel pad 2 preferably can also contain reinforcing elements 12 which increase the tinsel strength of the pad 2 to a value sufficient for preventing tearing of the pad 2 as it is being removed from the operating surface 10 of the ultrasonic delivering system 4. The reinforcing elements 12 can be made of several materials so long as they do not interfere with the passage of the ultrasonic pulses or degrade the hydro gel pad 2. Examples of such materials are organic plastic fibers or cotton fibers. Preferably organic plastic fibers.

The reinforcing elements 12 also perform another function. They promote rigidity to the hydro gel pad 2 and assist in maintaining the thickness “T” substantially constant during use thereof. By so maintaining the hydro gel pad 2 at a substantially constant thickness during use, the gel pad 2 is sized to maximize conduction and magnify the benefits of a more consistent beam pattern of the near field. In other words, the thickness of the gel pad 2 is sized relative to the operating parameters of the ultrasonic delivery system 4 and the depth of treatment desired. For these reasons, the hydro gel pad 2 has a thickness in the range of about twenty thousands of an inch (20/1,000) to about one hundred thousands of an inch (100/1,000) Thickness less than about twenty thousands of an inch are undesirable because of the inconsistency of beam pattern of the near field and the loss of cushioning effect which would make the treatment more painful and thickness more than about one hundred thousands of an inch are undesirable because effect gained by increased thickness would be most minimal and the extra thickness would represent a waste of materials, natural resources and labor.

It has also been discovered that the coupling cushion can be constructed to such a depth that the therapist is given the opportunity to treat virtually any anatomical structure with the far field, which presently can only be accomplished with a water bath. The coupling cushion can also be constructed such that the base is smaller than the transducer, thereby allowing the therapist to treat areas smaller than the transducer being used. With such construction, a first surface of the hydro gel pad 2 is adhereable to the operating surface 10 of the ultrasonic delivery system 4 and is of a greater area than the opposed second surface of the pad 2. For providing excellent conductivity, the hydro gel pad 2 is pliable and contains substantially no bubbles. Owing to its rigidity, air bubbles are also not introduced by moving the hydro gel pad 2 over the skin of the patient.

The composition of the conductive hydro gel pad 2 is an organic compound of the type generally referred to as glycerin based compound containing water and Polyacrylate co-polymer.

### INDUSTRIAL APPLICABILITY

In the method of this invention, an individual 14 is treated with therapeutic ultra sound via the operating surface of an ultra sound generating system. The skin of the individual is wetted with water at the area to be treated. A conductive, hydro gel pad of this invention is then connected over substantially the complete operative surface of the ultrasound generating system and the hydro gel pad is brought into intimate contact with the water wetted skin of the individual.

As set forth above, the physical and chemical properties of the conductive, hydro gel pad provides improved conductivity, improved efficiency, and a less messy operation which is less time consuming.

Other aspects, objects and advantages of this invention can be obtained from a study of the drawings, the disclosure, and the appended claims.

What is claimed is:

1. A coupling apparatus for a therapeutic ultrasonic delivery system, comprising:
first and second opposed, removable protective coverings; and
an adhereable, conductive hydro gel pad positioned between the removable protective coverings, said hydro gel pad having properties of being adhereable to an operating surface of a ultrasonic delivery system, and being removable therefrom in unitary form, and portions of said hydro gel pad, upon being subjected to water, becoming nonadherable.

2. The coupling apparatus, as set forth in claim 1, wherein the hydro gel pad has a thickness in the range of about 20/1000 inch to about 100/1000 inch.

3. The coupling apparatus, as set forth in claim 1, wherein the hydro gel pad contains reinforcing elements.

4. The coupling apparatus, as set forth in claim 3 wherein the reinforcing elements are selected from one of organic plastic film fibers and cotton fibers.

5. The coupling apparatus, as set forth in claim 1, wherein the hydro gel pad is substantially free of bubbles.

6. The coupling apparatus, as set forth in claim 1, wherein the hydro gel pad is of sufficient rigidity for the thickness of said pad to remain substantially constant during use.

7. The coupling apparatus, as set forth in claim 1, wherein the adhereable hydro gel pad is an organic glycerin based compound.

8. The coupling apparatus, as set forth in claim 1, wherein the adhereable, conductive hydro gel pad has a first and second opposed surfaces, said first surface being adhereable to the operating surface and the area of said first surface being greater than the area of said pad second surface.

9. An ultrasonic delivery system for therapeutic use, comprising:
an ultrasonic generating apparatus having an operative surface positionable adjacent a skin location of an individual; and
an adhereable, conductive hydro gel pad removeably connected to the operative surface of the ultrasonic generating means, said adhereable hydro gel pad having the physical property of having surface portions being nonadhereable in response to being wetted with water.

10. A method for treating an individual with therapeutic ultra sound via the operating surface of an ultrasound generating system, comprising:
applying water to the skin of the individual to be treated;
adhering a conductive hydro gel pad over substantially the complete operative surface of the ultrasound generating system, said hydro gel pad having the physical properties of being removable in unitary form and portions of said hydro gel pad, upon being subjected to water, being nonadherable; and
operating the ultrasound generating system with the operating face thereof and the conductive hydro gel pad in intimate contact with the water covered skin.
